(19) United States
(12) Patent Application Publication
(10) Pub. No.: US 2004/0264907 A1
(43) Pub. Date: Dec. 30, 2004

(54) MEMs variable optical attenuator having movable optical waveguide and method for operating movable optical waveguide

(76) Inventors: Jung Hyun Lee, Suwon (KR); Sung Cheon Jung, Suwon (KR); Yoon Shik Hong, Sungnam (KR)

Correspondence Address: LOWE HAUPTMAN GILMAN & BERNER, LLP, 1700 Diagonal Road, Suite 310, Alexandria, VA, 22314, US

(21) Appl. No.: 10/689,706

(22) Filed: Oct. 22, 2003

(30) Foreign Application Priority Data
Jun. 25, 2003 (KR) 2003-41391

(51) Int. Cl. G02B 6/26

(52) U.S. Cl. 385/140; 385/25

(57) ABSTRACT

Disclosed is a MEMS variable optical attenuator. The MEMS variable optical attenuator comprises a substrate having a flat upper surface; optical transmitting and receiving terminals arranged on the upper surface of the substrate; a movable optical waveguide arranged at a location such that it attenuates the maximum amount of light transmitted between the optical transmitting and receiving terminals; a micro actuator arranged on the substrate for moving the movable optical waveguide; and a voltage supply unit for supplying driving voltage to the micro actuator, wherein the micro actuator moves the movable optical waveguide so that the light attenuation amount is decreased in accordance with the increase in the driving voltage supplied from the voltage supply unit.

### BACKGROUND OF THE INVENTION

1. Field of the Invention

The present invention relates to a variable optical attenuator having a movable optical waveguide, and more particularly to a MEMS variable optical attenuator, in which the variation in a light attenuation amount is linearly achieved in accordance with the variation in driving voltage even in the lower driving voltage range.

2. Description of the Related Art

Optical communication systems have come into wide use, and techniques regarding optical communication apparatuses and devices have been vigorously developed. A variable optical attenuator (VOA) is one of these optical communication devices and adapted to change the amount of light transmitted from an optical transmitting terminal to an optical receiving terminal. Such a variable optical attenuator adapts a MEMS (Micro Electro Mechanical System) employing a semiconductor manufacturing process so that the attenuator has improved reliability and is minimized at a low production cost. This variable optical attenuator is referred to as a MEMS variable optical attenuator.

This MEMS variable optical attenuator comprises a micro actuator and a light blocking unit, formed on a silicon substrate. The micro actuator moves the light blocking unit to a location such that a part of the light transmitted from the optical transmitting terminal to the optical receiving terminal is blocked by the light blocking unit, thereby allowing the MEMS variable optical attenuator to generate a desirably attenuated light. The light blocking units are classified into two types, i.e., a cutoff film and an optical waveguide. The cut off film includes a surface coated with a reflective layer, which reflects the light transmitted between the optical transmitting and receiving terminals, thereby cutting off the light. The optical waveguide employs an optical fiber coinciding with optical axes of the optical transmitting and receiving terminals, and is moved so that the amount of the light passing through the core of the optical waveguide is controlled.

FIG. 1 is a perspective view of a conventional MEMS variable optical attenuator 50 having a movable optical waveguide 40.

With reference to FIG. 1, the MEMS variable optical attenuator 50 comprises a substrate 10 provided with an optical receiving terminal 15a and an optical transmitting terminal 15b arranged thereon, a micro actuator including fixed electrode units 20a and 20b and a movable electrode unit 30, and the movable optical waveguide 40 connected to the movable electrode unit 30. The movable electrode unit 30 includes a first comb unit 31, a ground electrode 35 fixed to the substrate 10, an elastic body 37 for connecting the first comb unit 31 and the ground electrode 35. The fixed electrode units 20a and 20b respectively include second comb units 21a and 21b, and driving electrodes 25a and 25b electrically connected to the second comb units 21a and 21b. The first comb unit 31 is interdigitated with the second comb units 21a and 21b.

In the MEMS variable optical attenuator 50, under the condition in which an electrical control signal is not inputted to the driving electrodes 25a and 25b, the first comb unit 31 is separated from the second comb units 21a and 21b by a designated distance. When a driving voltage is inputted to the driving electrodes 25a and 25b, an electric potential difference occurs between the fixed electrode units 20a and 20b and the movable electrode unit 30, and electrostatic force between the first comb unit 31 and the second comb units 21a and 21 is improved.

FIGS. 2a and 2b are schematic cross-sectional views illustrating the operation of the movable optical waveguide 40 of the MEMS variable optical attenuator 50 shown in FIG. 1. Under the condition in which a driving voltage is not supplied to the driving electrode units 25a and 25b, as shown in FIG. 2a, the first comb unit 31 is spaced from the second comb units 21a and 21b by a designated distance so that a core of the movable optical waveguide 40 is arranged on optical axes of the optical receiving and transmitting terminals 15a and 15b, thereby allowing the maximum amount of light to be transmitted. Thereafter, when the driving voltage is supplied to the driving electrode units 25a and 25b, as shown in FIG. 2b, electrostatic force occurs between the first comb unit 31 and the second comb units 21a and 21b. Thereby, the movable optical waveguide moves by a constant displacement (δ), and light attenuation equal to the displacement (light blocking distance) is obtained. That is, the desired light attenuation can be increased in accordance with the increase of the driving voltage. As described above, an insertion loss, i.e., the attenuation, is controlled by adjusting the connection area of the optical receiving and transmitting terminals 15a and 15b in accordance with the displacement of the movable optical waveguide 50. Preferably, the variation in the light attenuation is linearly achieved in accordance with the variation in the driving voltage supplied to the micro actuator (i.e., the driving electrode units 25a and 25b). However, this conventional MEMS variable optical attenuator is disadvantageous in that the linear variation of the light attenuation does not occur in the low driving voltage range.

More specifically, the variation in the light attenuation will be described in more detail with reference to FIG. 3. FIG. 3 is a graph illustrating the variation of a light attenuation amount in accordance with the operation of the movable optical waveguide of the conventional MEMS variable optical attenuator.

As shown in FIG. 3, the light attenuation amount is generally increased by the increase of the driving voltage supplied to the micro actuator. However, the variation in the light attenuation amount does not appear in the low driving voltage range of less than approximately 6V, regardless of the variation of the driving voltage. The reason is that the curve of the variation in the light attenuation amount in accordance with a light blocking distance defined by an interval between the core of the optical waveguide and the core of the optical transmitting terminal shows one-dimensional Gaussian distribution. For example, the light amount expressed by a function of a three degree regarding the displacement of the optical waveguide is decreased from a point of time where the light blocking distance is more than 50%, and the light blocking distance is directly proportional to the square of the driving voltage.

Consequently, the light attenuation amount remains unchanged in the low driving voltage range. However, when the driving voltage is higher, the variation in the light attenuation amount is larger (for example, (dB)=V⁵, herein, dB is the light attenuation amount, and V is the driving voltage).

Accordingly, in the conventional MEMS variable optical attenuator, it is difficult to obtain the linearity of the variation in the light attenuation amount in accordance with the variation in the driving voltage. Thus, the conventional MEMS variable optical attenuator has a difficulty of precisely controlling a desired light attenuation amount by adjusting applied voltage.

### SUMMARY OF THE INVENTION

Therefore, the present invention has been made in view of the above problems, and it is an object of the present invention to provide a MEMS variable optical attenuator comprising a movable optical waveguide, which achieves the linear variation in a light attenuation amount in accordance with the variation in driving voltage applied to a micro actuator.

It is another object of the present invention to provide a method for operating a movable optical waveguide, which achieves the linear variation in a light attenuation amount in accordance with the variation in driving voltage applied to a micro actuator.

In accordance with one aspect of the present invention, the above and other objects can be accomplished by the provision of a MEMS (Micro Electro Mechanical System) variable optical attenuator comprising: a substrate having a flat upper surface; optical transmitting and receiving terminals arranged on the upper surface of the substrate so that optical axes of the terminals coincide with each other; a movable optical waveguide arranged at a location such that it attenuates the maximum amount of light transmitted between the optical transmitting and receiving terminals; a micro actuator arranged on the substrate for moving the movable optical waveguide; and a voltage supply unit for supplying driving voltage to the micro actuator, wherein the micro actuator moves the movable optical waveguide so that the light attenuation amount is decreased in accordance with the increase in the driving voltage applied by the voltage supply unit.

Preferably, the movable optical waveguide may be arranged at a location such that it completely blocks the light transmitted between the optical transmitting and receiving terminals when the driving voltage is 0, and moved to another location such that it passes at least a part of the light transmitted between the optical transmitting and receiving terminals when the voltage supply unit begins to supply the driving voltage to the micro actuator.

Further, in order to allow the variation in the light attenuation amount to be proportional to the variation in the input voltage, preferably, the voltage supply unit may include a differential circuit unit for decreasing the driving voltage to be outputted in accordance with the increase in input voltage.

The movable optical waveguide may have two structures, i.e., one structure in which the movable optical waveguide moves in the direction perpendicular to the optical axes, and the other structure in which the movable optical waveguide rotates centering around the optical axes.

Preferably, the micro actuator may include a movable electrode unit arranged on the substrate and provided with a first comb unit moving in the direction perpendicular to the optical axes; and a driving electrode unit fixed to the substrate and provided with a second comb unit interdigitated with the first comb unit. In this case, the movable electrode unit is arranged between the driving electrode unit and the optical axes of the optical transmitting and receiving terminals.

Alternatively, the micro actuator may include a driving electrode unit fixed to the substrate; and a movable electrode unit hinged to the substrate, and provided with a first terminal separated from the upper surface of the driving electrode by a certain distance and a second terminal connected to the movable optical waveguide so that the second terminal moves upward and downward.

In accordance with another aspect of the present invention, there is provided a method for operating a movable optical waveguide so as to attenuate light to a desired amount, the light transmitted between optical transmitting and receiving terminals arranged on an upper surface of a substrate so that optical axes of the terminals coincide with each other, comprising the steps of: (a) arranging the movable optical waveguide at an initial location such that it attenuates the maximum amount of light transmitted between the optical transmitting and receiving terminals; and (b) moving the movable optical waveguide so that the light attenuation amount is decreased by the increase in driving voltage.

Preferably, the driving voltage for moving the movable optical waveguide may be supplied so that the driving voltage is inversely proportional to input voltage.

In the MEMS variable optical attenuator of the present invention, the movable optical waveguide is arranged at an initial location such that the light attenuation amount obtained by the attenuator is the maximum value, and then moved to another location such that the light attenuation amount is decreased in accordance with the supply of the driving voltage. Accordingly, the MEMS variable optical attenuator of the present invention offsets the non-linear higher functional relation between the driving voltage and the light blocking distance and the non-linear higher functional relation between the light blocking distance and the light attenuation amount, thereby obtaining the linearity of the variation in the light attenuation amount in accordance with the variation in the driving voltage close to the function of the first degree and assuring the precision in controlling the light attenuation amount.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a conventional MEMS variable optical attenuator;

FIGS. 2a and 2b are schematic cross-sectional views illustrating the operation of a movable optical waveguide of the conventional MEMS variable optical attenuator;

FIG. 3 is a graph illustrating the variation of a light attenuation amount in accordance with the operation of the movable optical waveguide of the conventional MEMS variable optical attenuator;

FIG. 4a is a perspective view of a MEMS variable optical attenuator in accordance with one embodiment of the present invention;

FIG. 4b is a partial cross-sectional view of a movable optical waveguide of the MEMS variable optical attenuator in accordance with one embodiment of the present invention;

FIGS. 5a and 5b are graphs illustrating the relation among the driving voltage, light blocking distance and light attenuation amount of the conventional MEMS variable optical attenuator and the MEMS variable optical attenuator of the present invention, respectively; and

FIGS. 6a and 6b are graphs illustrating the variation of a light attenuation amount in accordance with the operation of the movable optical waveguide of each of two MEMS variable optical attenuators of the present invention, respectively.

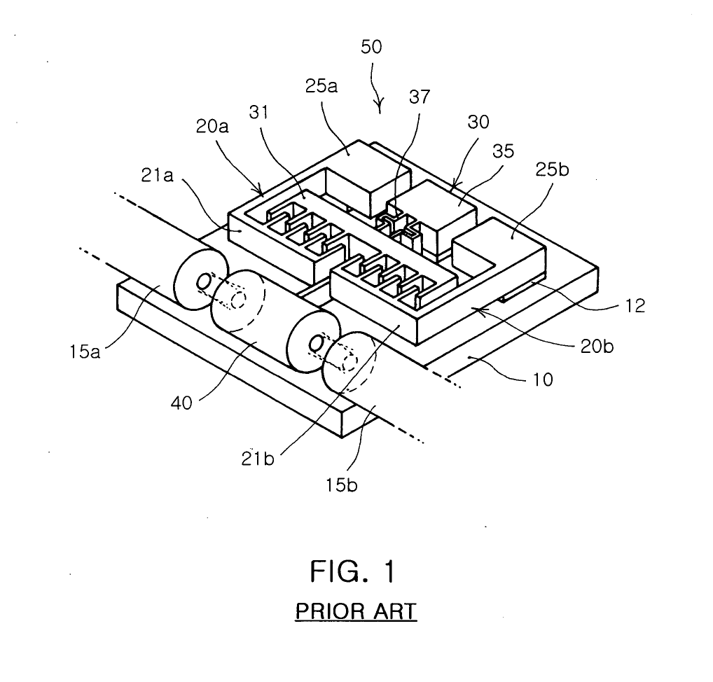

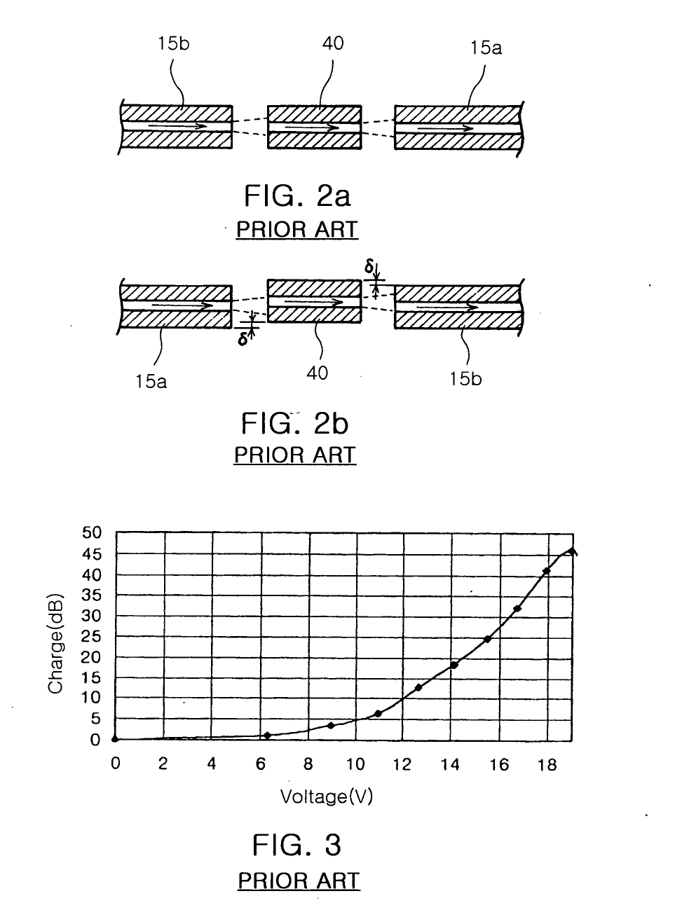

### DESCRIPTION OF THE PREFERRED EMBODIMENTS

Now, preferred embodiments of the present invention will be described in detail with reference to the annexed drawings.

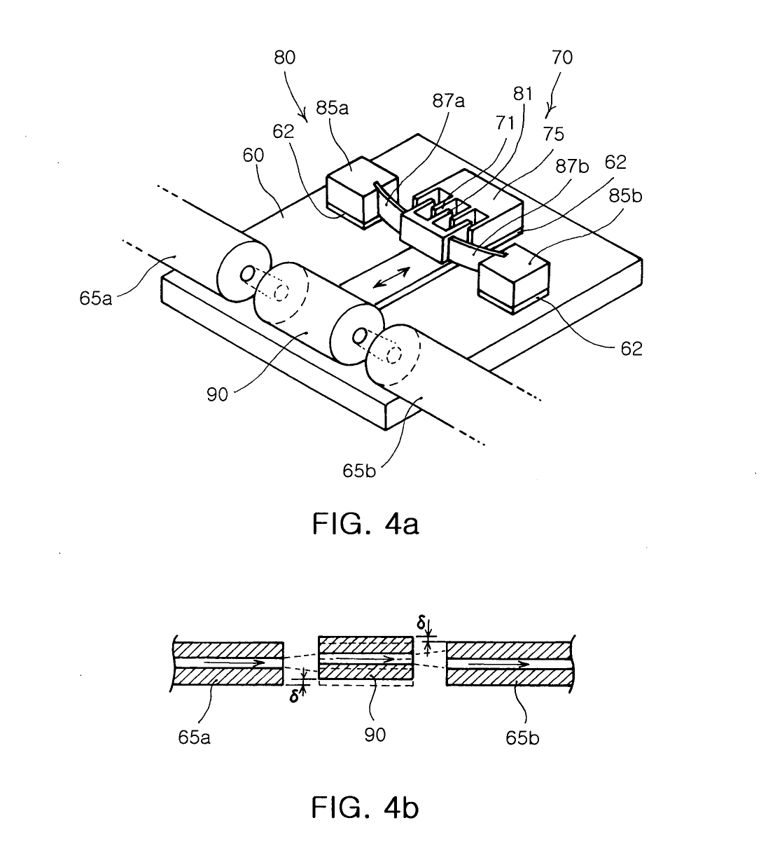

FIG. 4a is a perspective view of a MEMS variable optical attenuator 100 in accordance with one embodiment of the present invention. The MEMS variable optical attenuator of this embodiment is provided with a comb actuator.

With reference to FIG. 4a, the MEMS variable optical attenuator 100 comprises a substrate 60 provided with an optical receiving terminal 65a and an optical transmitting terminal 65b arranged thereon, a micro actuator including a fixed electrode unit 70 and a movable electrode unit 80, and a movable optical waveguide 90 connected to the movable electrode unit 80. The movable electrode unit 80 includes ground electrodes 85a and 85b fixed to the substrate 60, and a first comb unit 81 connected to the ground electrodes 85a and 85b by elastic structures 87a and 87b. The movable optical waveguide 90 is arranged at one side of the movable electrode unit 80. The fixed electrode 70 includes a second comb unit 71 and a driving electrode 75 connected to the second comb unit 71. Here, the second comb unit 71 is interdigitated with the first comb unit 81.

In the MEMS variable optical attenuator 100 of the present invention, the movable optical waveguide 90 is arranged at an initial location such that light transmitted between the optical receiving and transmitting terminals 65a and 65b is attenuated by a predetermined maximum value. Preferably, the initial location of the movable optical waveguide 30 having the maximum attenuation amount of the light is set so that light is completely blocked when a driving voltage is not applied, and then can be changed to another location so that the light is partially transmitted when the driving voltage begins to be applied.

Thereby, when the driving voltage from a voltage supply unit (not shown) is not supplied to the driving electrode 75, the MEMS variable optical attenuator 100 blocks light transmitted between the optical receiving and transmitting terminals 65a and 65b by the maximum attenuation amount. However, when the driving voltage is supplied to the driving electrode 75, electrostatic force acting between the first comb unit 81 and the second comb unit 71 is generated, and the movable optical waveguide 90 moves in the direction of an arrow, thus allowing the light attenuation amount to be reduced.

Hereinafter, with reference to FIG. 4b, a method for operating the movable optical waveguide of the MEMS variable optical attenuator of the present invention will be described in detail. FIG. 4b is a partial cross-sectional view of a movable optical waveguide of the MEMS variable optical attenuator in accordance with one embodiment of the present invention.

As shown in FIG. 4b, under the condition in which a driving voltage is not applied to the driving electrode, the movable optical waveguide 90 is arranged at an initial location such that light transmitted between the optical receiving terminal 65a and the optical transmitting terminal 65b is completely blocked. Here, when the initial location of the movable optical waveguide 90 moves by a small distance in a designated direction, the movable optical waveguide 90 is arranged at a new location such that the light transmitted between the optical receiving terminal 65a and the optical transmitting terminal 65b passes through the core of the movable optical waveguide 90, thereby beginning to decrease the light attenuation amount.

First, when the driving voltage with a designated value is supplied to the micro actuator, the first comb unit 81 connected to the movable optical waveguide 90 moves close to the second comb unit 71, as shown in FIG. 4a. Then, the movable optical waveguide 90 moves to the location such that the core of the movable optical waveguide 90 can pass through the light transmitted between the optical receiving and transmitting terminals 65a and 65b. Accordingly, the maximum attenuation amount set at the initial stage (when the driving voltage is 0V) is decreased, and when the driving voltage reaches a designated value, the movable optical waveguide 90 moves to yet another location shown in a dotted line such that the light attenuation value is 0.

Further, the present invention may be applied to another MEMS variable optical attenuator having a micro actuator with a structure differing from that of the micro actuator of the MEMS variable optical attenuator shown in FIG. 4a. That is, the present invention may be applied to a MEMS variable optical attenuator having a flat-type micro actuator including a driving electrode unit fixed to a substrate, and a movable electrode unit hinged to the substrate and provided with a first terminal separated from the upper surface of the driving electrode by a certain distance and a second terminal connected to the movable optical waveguide so that the second terminal moves upward and downward.

In accordance with the principle of the operation of the MEMS variable optical attenuator of the present invention, the MEMS variable optical attenuator offsets the non-linear higher functional relation between the driving voltage and the light blocking distance and the non-linear higher functional relation between the light blocking distance and the light attenuation amount, thereby obtaining the linearity of the variation in the light attenuation amount in accordance with the variation in the driving voltage.

More specifically, driving force (F) is defined by driving voltage (V), as follows.

F=en_{c}t/g×V²

(Herein, e: permittivity, n_{c}: number of combs, t: thickness of comb, and g: gap between combs)

Displacement (d) of the optical waveguide is obtained by the above equation regarding the driving force (F), as follows.

d[μm]=f/k=en_{c}t/(kd)×V²

(Herein, k: elasticity of an elastic structure)

Accordingly, the relation between the driving voltage (V) and the displacement (d) of the optical waveguide is expressed, as follows.

d[μm]∝V²

Further, a light attenuation amount (A) is in higher functional relation to a light blocking distance (δ), which is defined by the displacement of the optical waveguide, and for example, is expressed by a function of a three degree, as follows.

A[dB]=aδ³+bδ²+cδ+d

(Herein, a, b, c, and d: constant)

Consequently, in case that the conventional operating method in which the light attenuation amount is increased by the supply of the driving voltage from when the initial attenuation amount is 0, the final light attenuation amount in accordance with the driving voltage is defined, as follows.

A[dB]=αV⁵+βV⁴+γV³+εV²+d

(Herein, α, β, γ, and ε: constant)

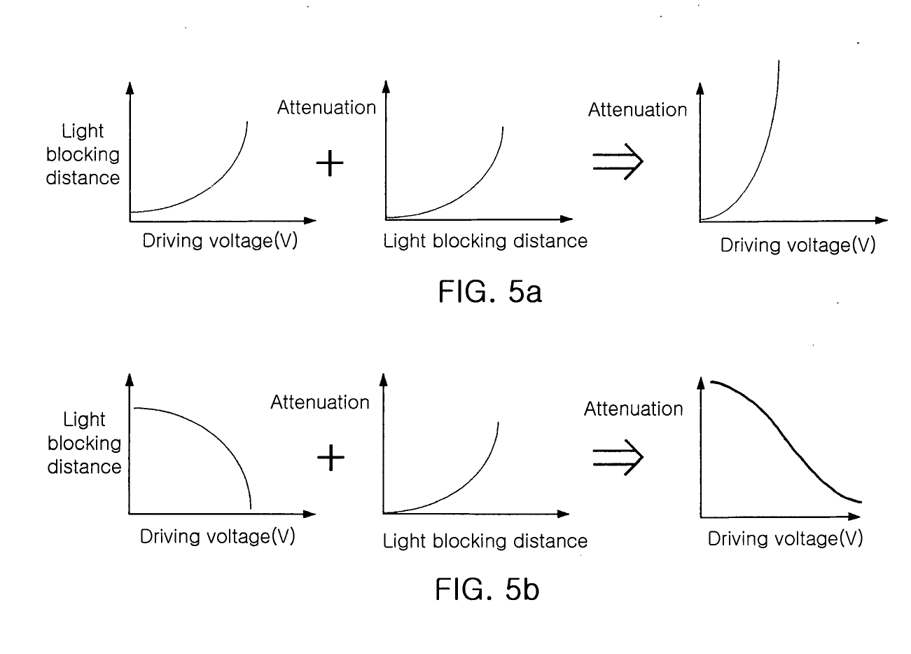

The final relation between the driving voltage and the light attenuation amount obtained by the relation between the light blocking distance and the driving voltage and the relation between the light blocking distance and the light attenuation amount is described in more detail with reference to FIG. 5a.

On the other hand, in case of the operating method of the present invention in which the movable optical waveguide is arranged such that the light blocking distance (δmax) with the maximum attenuation amount is obtained when the driving voltage is 0, and then the light blocking distance is decreased in accordance with the increase of the driving voltage, the relation between the driving voltage and the light blocking distance is expressed, as follows.

d[μm]=1/KV²

Accordingly, in case that the relation between the light blocking distance and the light attenuation amount of FIG. 5b is the same as that of FIG. 5a, the light attenuation amount is linearly and inversely proportional to the driving voltage.

As described above, the MEMS variable optical attenuator of the present invention comprises the movable optical waveguide arranged such that the movable optical waveguide has the maximum light attenuation amount at an initial stage, and then increases a light transmission amount in accordance with the supply of the driving voltage, thereby obtaining a comparatively linear relation between the driving voltage and the light attenuation amount.

Accordingly, it is possible to achieve the variation of the light attenuation amount in the range of low voltage, and to more exactly control the light attenuation amount without any additional voltage control unit.

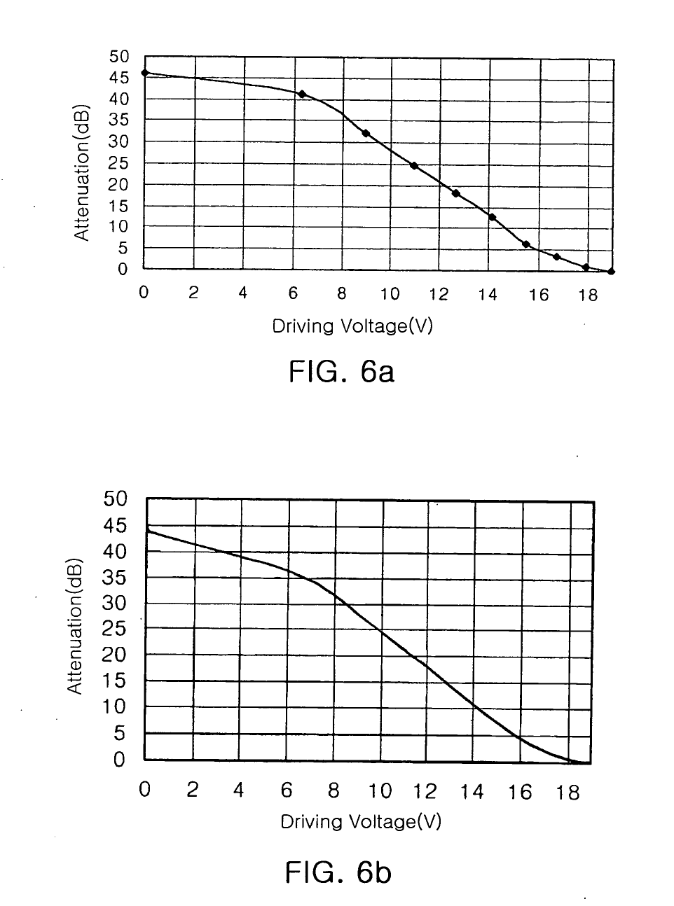

FIGS. 6a and 6b illustrate the variation in the light attenuation amount of the MEMS variable optical attenuator of the present invention in accordance with the variation in the driving voltage.

More specifically, FIG. 6a illustrates the obtained result from a linear driving-type attenuator in which a movable optical waveguide moves such that it is perpendicular to an optical axial direction of optical receiving and transmitting terminals, and FIG. 6b illustrates the obtained result from a rotary driving-type attenuator in which a movable optical waveguide moves such that it is offset at a constant angle along an optical axial direction of optical receiving and transmitting terminals. Each of the movable optical waveguides employed in FIGS. 6a and 6b includes a regular square-shaped core with a refractivity of 1.4501 and a length of each side of 8 μm, and a regular square-shaped clad with a refractivity of 1.445 and a length of each side of 30 μm. In order to obtain a sufficient light attenuation amount, the movable optical waveguide of FIG. 6a has a length of 1,600 μm, and the movable optical waveguide of FIG. 6b has a length of 2,500 μm.

With reference to FIGS. 6a and 6b, it is noted that the light attenuation amount is generally decreased in accordance with the increase of the driving voltage. That is, when the driving voltage is 0 at the initial stage, the light attenuation amounts of two cases respectively have maximum values (44 dB and 46 dB). Then, the light attenuation amounts of two cases are linearly decreased in accordance with the increase of the driving voltage, and finally reach 0 when the driving voltage is 19V.

As described above, the variation in the light attenuation amount is linearly achieved in accordance with the variation in the driving voltage. Particularly, the variation in the light attenuation amount is achieved even in the range of low voltage less than 6V, and the variation in the light attenuation amount is linearly achieved in accordance with the variation in the driving voltage in the range of a low attenuation amount (15 dB).

The constitution of the voltage supply unit of the MEMS variable optical attenuator of the present invention may be modified so that the linearity of the variation of the light attenuation amount in accordance with the variation of the driving voltage is maintained, while the variation of the light attenuation amount is directly proportional to input voltage.

In this case, the voltage supply unit further includes a differential driving amplifier for outputting the driving voltage corresponding to the difference between input voltage (Vᵢ) and the designated maximum voltage (Vₘₐₓ), thus being capable of driving the micro actuator so that the variation in the light attenuation amount is directly proportional to the variation in the input voltage. Here, the designated maximum voltage is referred to as voltage, which allows the movable optical waveguide to move to the location where the waveguide has the light attenuation amount of 0. Such a voltage supply unit including the differential driving amplifier provides is advantageous in that the linearity of the variation in the light attenuation amount in accordance with the variation in the driving voltage is maintained, while the variation in the light attenuation amount is directly proportional to the variation in the input voltage.

As apparent from the above description, the present invention provides a MEMS variable optical attenuator comprising a movable optical waveguide arranged in a location such that the waveguide obtains the maximum light attenuation amount, and a method for operating the movable optical waveguide, in which a micro actuator is driven so that the light attenuation amount is decreased by the increase of the driving voltage and the variation in the light attenuation amount is achieved even in the low voltage range, thereby obtaining the linearity of the variation in the light attenuation amount in accordance with the variation in the driving voltage. Accordingly, the MEMS variable optical attenuator precisely controls the variation in the light attenuation amount using the driving voltage without any additional voltage control circuit.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A MEMS (Micro Electro Mechanical System) variable optical attenuator comprising:
a substrate having a flat upper surface;
optical transmitting and receiving terminals arranged on the upper surface of the substrate so that optical axes of the terminals coincide with each other;
a movable optical waveguide arranged at a location such that it attenuates the maximum amount of light transmitted between the optical transmitting and receiving terminals;
a micro actuator arranged on the substrate for moving the movable optical waveguide; and
a voltage supply unit for supplying driving voltage to the micro actuator,
wherein the micro actuator moves the movable optical waveguide so that the light attenuation amount is decreased in accordance with the increase in the driving voltage applied by the voltage supply unit.

2. The MEMS variable optical attenuator as set forth in claim 1,
wherein the movable optical waveguide is arranged at a location such that it completely blocks the light transmitted between the optical transmitting and receiving terminals when the driving voltage is 0, and moved to another location such that it passes at least a part of the light transmitted between the optical transmitting and receiving terminals when the voltage supply unit begins to supply the driving voltage to the micro actuator.

3. The MEMS variable optical attenuator as set forth in claim 1,
wherein the voltage supply unit includes a differential circuit unit for decreasing the driving voltage to be outputted in accordance with the increase of input voltage.

4. The MEMS variable optical attenuator as set forth in claim 1,
wherein the movable optical waveguide moves in the direction perpendicular to the optical axes.

5. The MEMS variable optical attenuator as set forth in claim 1,
wherein the movable optical waveguide rotates centering around the optical axes.

6. The MEMS variable optical attenuator as set forth in claim 1,
wherein the micro actuator includes:
a movable electrode unit arranged on the substrate and provided with a first comb unit moving in the direction perpendicular to the optical axes; and
a driving electrode unit fixed to the substrate and provided with a second comb unit interdigitated with the first comb unit.

7. The MEMS variable optical attenuator as set forth in claim 6,
wherein the movable electrode unit is arranged between the driving electrode unit and the optical axes of the optical transmitting and receiving terminals.

8. The MEMS variable optical attenuator as set forth in claim 1,
wherein the micro actuator includes:
a driving electrode unit fixed to the substrate; and
a movable electrode unit hinged to the substrate, and provided with a first terminal separated from the upper surface of the driving electrode by a certain distance and a second terminal connected to the movable optical waveguide so that the second terminal moves upward and downward.

9. A method for operating a movable optical waveguide so as to attenuate light to a desired amount, said light transmitted between optical transmitting and receiving terminals arranged on an upper surface of a substrate so that optical axes of the terminals coincide with each other, comprising the steps of:
(a) arranging the movable optical waveguide at an initial location such that it attenuates the maximum amount of light transmitted between the optical transmitting and receiving terminals; and
(b) moving the movable optical waveguide so that the light attenuation amount is decreased by the increase in driving voltage.

10. The method as set forth in claim 9,
wherein the movable optical waveguide arranged at the initial location completely blocks the light transmitted between the optical transmitting and receiving terminals when the driving voltage is 0, and then is moved to another location such that it passes at least a part of the light transmitted between the optical transmitting and receiving terminals when the driving voltage begins to be supplied.

11. The method as set forth in claim 9,
wherein the driving voltage for moving the movable optical waveguide is inversely proportional to input voltage.

12. The method as set forth in claim 9,
wherein the step (b) includes the step of moving the movable optical waveguide in the direction perpendicular to the optical axes.

13. The method as set forth in claim 9,
wherein the step (b) includes the step of rotating the movable optical waveguide centering around the optical axes.
